(19) United States
(12) Patent Application Publication
(10) Pub. No.: US 2012/0162135 A1
(43) Pub. Date: Jun. 28, 2012

(54) OPTICAL TOUCH APPARATUS

(75) Inventor: KUN-HSUN LEE, NEW TAIPEI CITY (TW)

(73) Assignee: LITE-ON SEMICONDUCTOR CORP., NEW TAIPEI CITY (TW)

(21) Appl. No.: 13/086,742

(22) Filed: Apr. 14, 2011

(30) Foreign Application Priority Data
Dec. 24, 2010 (CN) 201010613440.6

(51) Int. Cl. G06F 3/042

(52) U.S. Cl. 345/175

(57) ABSTRACT

An optical touch apparatus includes: a frame having a first side that has a first connecting unit; a lighting module for generating light, the lighting module having a second connecting unit connected to the first connecting unit of the first side of the frame such that the lighting module is mounted to the first side of the frame; and two optical sensors mounted on the frame and disposed respectively at two corners of the frame, each of the optical sensors sensing the light generated by the lighting module.

### CROSS-REFERENCE TO RELATED APPLICATION

This application claims priority of Chinese Application No. 201010613440.6, filed on Dec. 24, 2010.

### BACKGROUND OF THE INVENTION

1. Field of the Invention

The invention relates to an optical touch apparatus, and more particularly to an optical touch apparatus capable of positioning lighting modules in a frame.

2. Description of the Related Art

A conventional optical touch sensing apparatus disclosed in Taiwanese Patent No. 14358363 includes a processing module disposed in a frame, and first and second image capturing modules mounted on the frame. The first and second image capturing modules are connected electrically to the processing module through ribbon cables or electric wires arranged in the frame. Arrangement for the ribbon cables or the electric wires may be complicated. Thus, it may take more time to assemble the conventional optical touch sensing apparatus. Improvements may be made in the above techniques.

### SUMMARY OF THE INVENTION

Therefore, an object of the present invention is to provide an optical touch apparatus that can overcome the aforesaid drawbacks of the prior art.

According to the present invention, an optical touch apparatus comprises:

a frame having a first side and two corners, the first side of the frame having a first connecting unit;

a lighting module for generating light, the lighting module having a second connecting unit connected to the first connecting unit of the first side of the frame such that the lighting module is mounted to the first side of the frame; and

two optical sensors mounted on the frame and disposed respectively at the corners of the frame, each of the optical sensors sensing the light generated by the lighting module.

### BRIEF DESCRIPTION OF THE DRAWINGS

Other features and advantages of the present invention will become apparent in the following detailed description of the preferred embodiments with reference to the accompanying drawings, of which:

FIG. 1 is a top perspective view showing the first preferred embodiment of an optical touch apparatus according to the present invention;

FIG. 2 is a bottom perspective view showing the first preferred embodiment;

FIG. 3 is a schematic top view showing the first preferred embodiment;

FIG. 4 is an exploded perspective view showing a frame, and first and second lighting modules of the first preferred embodiment;

FIG. 5 is a fragmentary exploded perspective view showing the frame and the first lighting module of the first preferred embodiment;

FIG. 6 is a fragmentary exploded perspective view showing the frame and the second lighting module of the first preferred embodiment;

FIG. 7 is a top showing the second, preferred embodiment of an optical touch apparatus according to the present invention;

FIG. 8 is a partially exploded perspective view showing the second preferred embodiment;

FIG. 9 is a perspective view showing the first preferred embodiment of an optical touch apparatus according to the present invention;

FIG. 10 is an exploded perspective view showing a frame and lighting modules of the first preferred embodiment;

FIG. 11 is a perspective view showing the third preferred embodiment of an optical touch apparatus according to the present invention; and

FIG. 12 is an exploded perspective view showing a frame and light modules of the third preferred embodiment.

### DETAILED DESCRIPTION OF THE PREFERRED EMBODIMENTS

Before the present invention is described in greater details it should be noted that like elements are denoted by the same reference numerals throughout the disclosure.

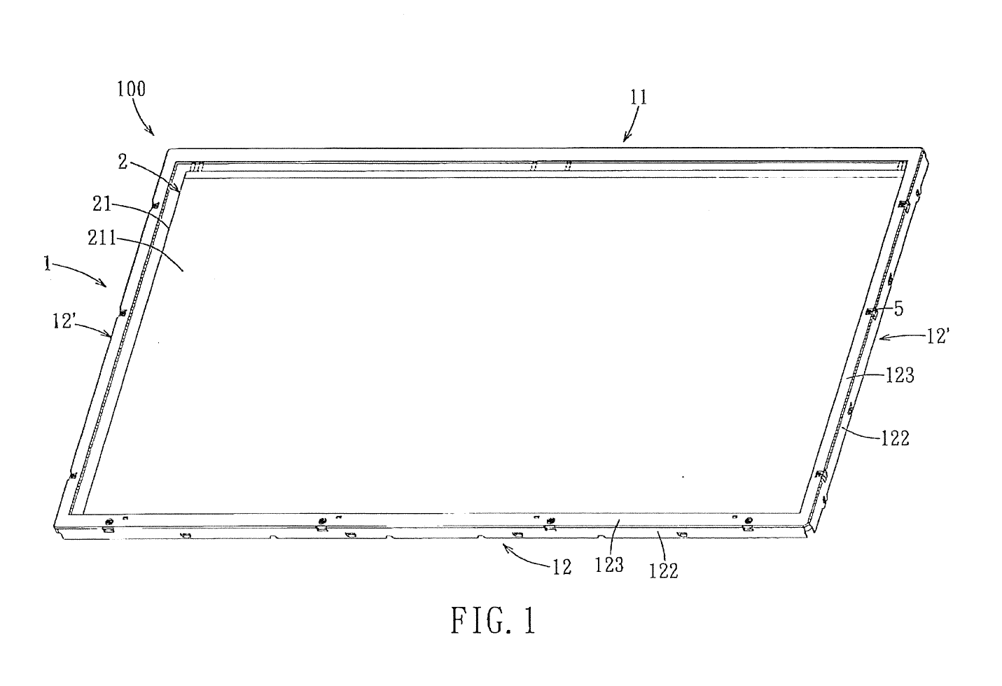

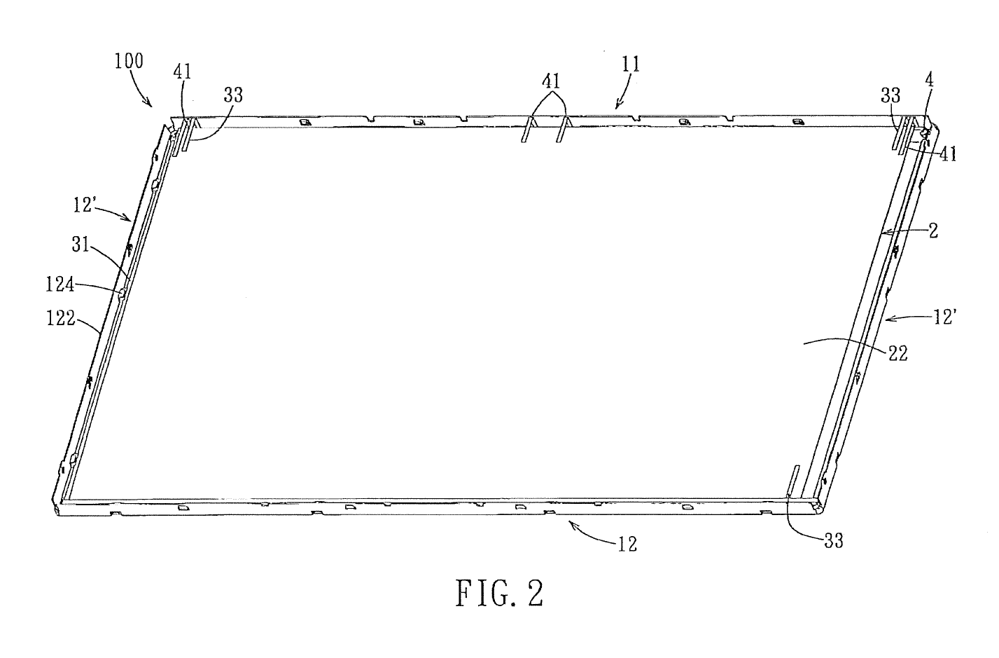

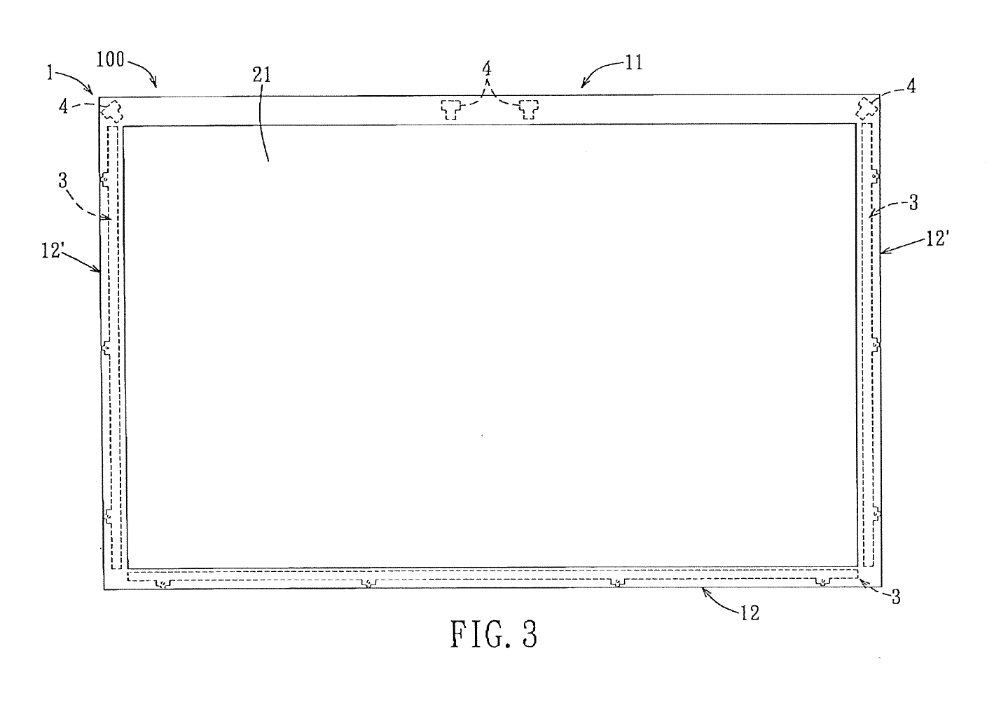

Referring to FIGS. 1 to 3, the first preferred embodiment of an optical touch apparatus 100 according to the present invention is shown to include a rectangular frame 1, a panel module 2, three lighting modules 3, 3′, and four optical sensors 4.

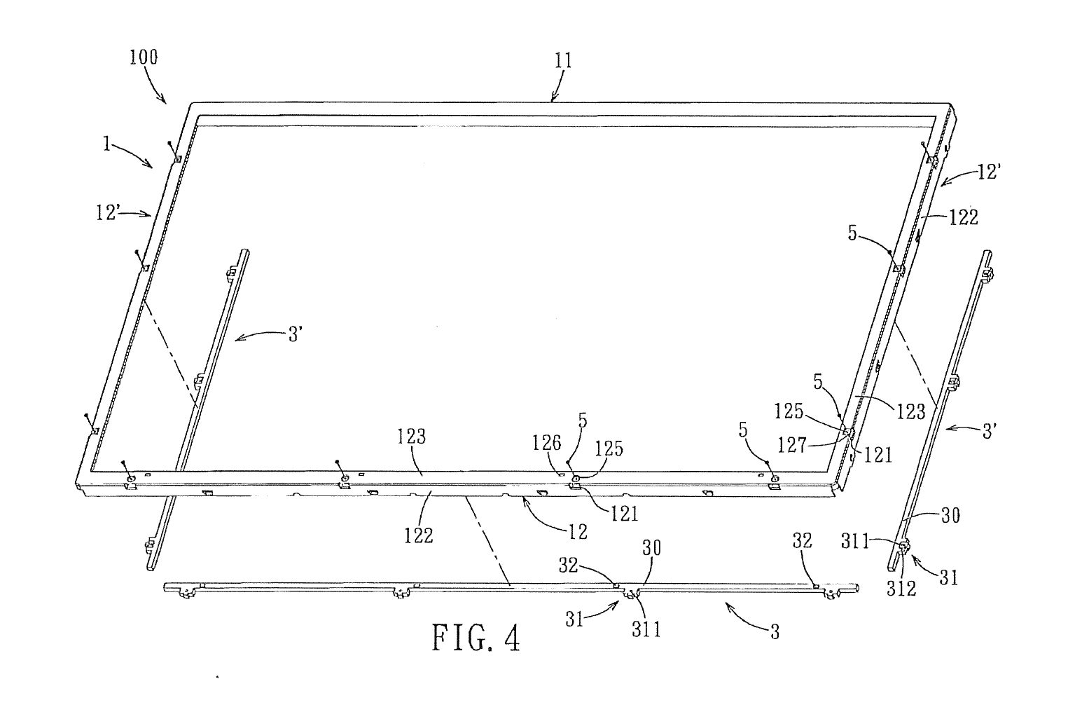

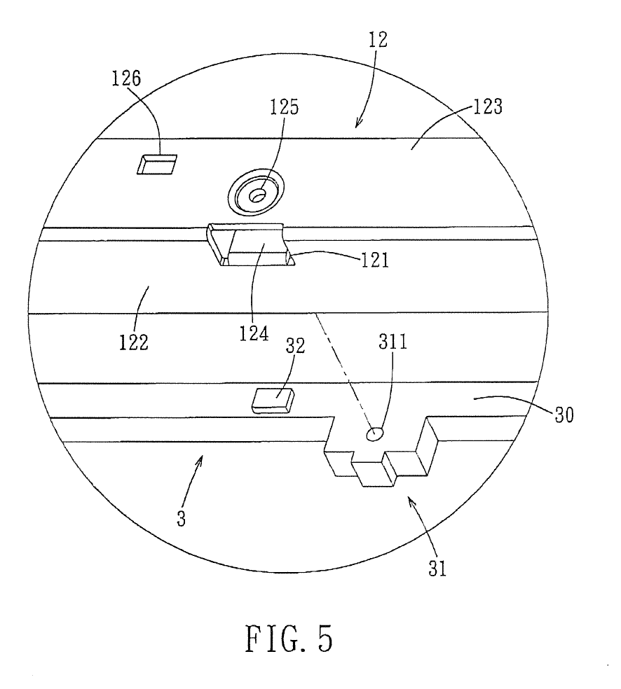

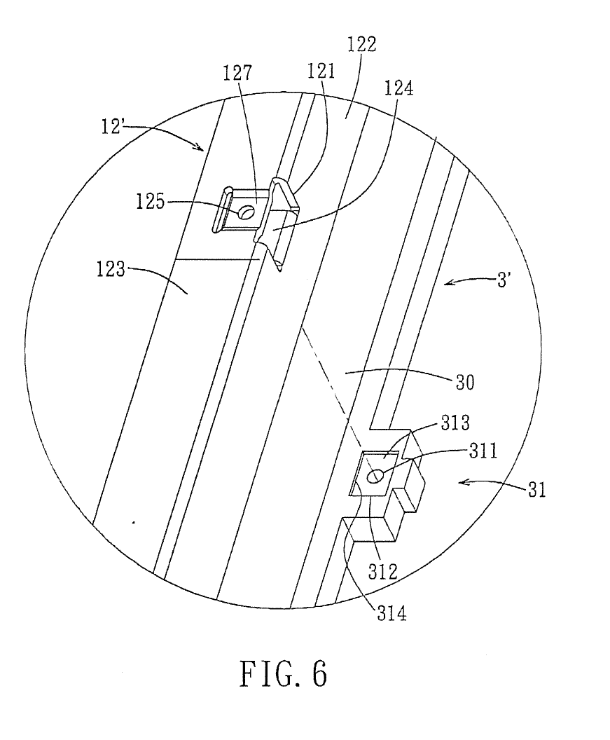

Referring further to FIGS. 4 to 6, the frame 1 is made of metal. The frame 1 has a first side, i.e., a front side 12, second and third sides, i.e., opposite lateral sides 12′, and a fourth side, i.e., a rear side 11. Each of the front side 12 and the lateral sides 12′ has a side plate 122, a stop plate 123 extending inward from a top side of the side plate 122, and a first connecting unit. In this embodiment, for each of the front side 12 and the lateral sides 12′, the side plate 122 is formed with a plurality of engaging holes 121 that serve as the first connecting unit, and the stop plate 123 is formed with a plurality of through holes 125 corresponding respectively to the engaging holes 121. In addition, each of the front side 12 and the lateral sides 12′ further has a clipping tab 124 extending inward from the side plate 122 and spaced apart from the stop plate 123.

Furthermore, in this embodiment, each of the front side 12 and the lateral sides 12′ of the frame 1 further has a first positioning unit. The stop plate 123 of the front side 12 is formed with a plurality of positioning holes 126 that serve as the first positioning unit of the front side 12. The stop plate 123 of each lateral side 12′ is formed with a plurality of downward extending positioning protrusions 127 that serve as the first positioning unit of a corresponding lateral side 12′ It is noted that each through hole 125 in the stop plate 123 of each lateral side 12′ extends through a corresponding positioning protrusion 127.

The panel module 2 is mounted in the frame 1, and includes a panel 21 having a touch surface 211, and a circuit board 22 disposed under the panel 21.

The lighting modules 3, 3′ are respectively mounted to the front and lateral sides 12, 12′ of the frame 1 for generating light that propagates along the touch surface 211 of the panel module 2. Each of the lighting modules 3, 3′ is connected electrically to the circuit board 22 of the panel module 2 through a first electric wire 31. Each of the lighting modules 3, 3′ has a second connecting unit connected to the first connecting unit of a corresponding one of the front and lateral sides 12, 12′ of the frame 1. In this embodiment, each of the lighting modules 3, 3′ has a main body 30, and a plurality of engaging blocks 31 that extend from the main body 30 and that serve as the second connecting unit. For each of the lighting modules 3, 3′, each engaging block 31 extends into and engages a corresponding engaging hole 121 in the corresponding one of the front and lateral sides 12, 12′ of the frame 1, and is clamped between the stop plate 123 and a corresponding clipping tab 124 of the corresponding one of the front and lateral sides 12, 12′ of the frame 1. In addition, each engaging block 31 is formed with a connecting hole 311, such as a threaded hole, corresponding to a corresponding through hole 125 in the stop plate 123 of the corresponding one of the front and lateral sides 12, 12′ of the frame 1. Each engaging block 31 is anchored to the stop plate 13 of the corresponding one of the front and lateral sides 12, 12′ of the frame 1 by a screw fastener 5 extending through the corresponding through hole 125 and secured in the connecting hole 311.

Furthermore, in this embodiment, each of the lighting modules 3, 3′ further has a second positioning unit engaging the second positioning unit of a corresponding one of the front and lateral sides 12, 12′ of the frame 1. The lighting module 3 further has a plurality of positioning protrusions 32 that extend upward from the main body 30, that serve as the second positioning unit of the lighting module 3, and that extend into and engage the positioning holes 126 in the stop plate 123 of the front side 12 of the frame. Each lighting module 3′ is formed with a plurality of positioning grooves 312 that serve as the second positioning unit of a corresponding lighting module 3′. For each lighting module 3′, each positioning groove 312 is formed in a corresponding one of the engaging blocks 31, and is defined by an inner surrounding wall 314, and a groove-bottom wall 313 formed with the connecting hole 311.

The optical sensors 4, such as image sensors, are mounted to the rear side 11 of the frame 1, and are placed around the periphery of the panel 21 of the panel module 2. In this embodiment, two optical sensors 4 are disposed respectively at two adjacent corners of the frame 1. The optical sensors 4 detects an interruption, which is produced by an object, such as a user's finger, in a light region defined by the lighting modules 3, 3′ to locate the object. Each optical sensor 4 is connected electrically to the circuit board 22 of the panel module 2 through a second electric wire 41.

In sum, due to the presence of the first and second connecting units and the first and second positioning units, the lighting modules 3, 3′ can be accurately positioned and quickly assembled to the frame 1. Furthermore, because each of the first and second electric wires 33, 41 can be easily arranged to have a shorter length, the optical touch apparatus of this invention can reduce signal attenuation and noise interference. In addition, wire entanglement can be avoided during assembly. Therefore, the optical touch apparatus of this invention can be assembled in a reduced time period.

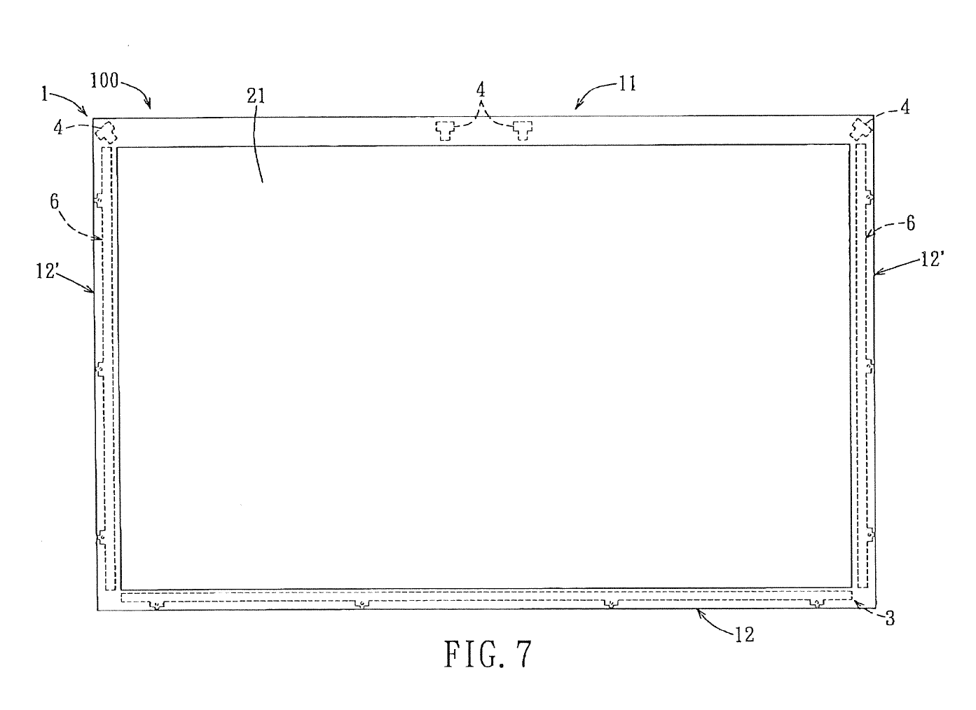

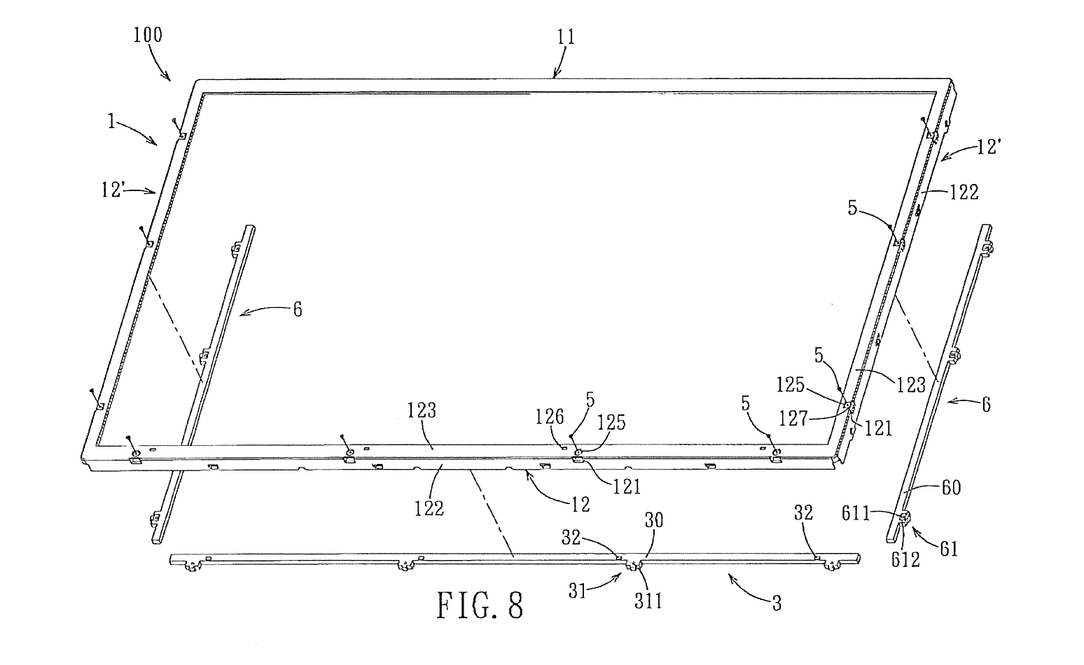

FIGS. 7 and 8 illustrate the second preferred embodiment of an optical touch apparatus 100 according to this invention, which is a modification of the first preferred embodiment. Unlike the previous embodiment, the optical touch apparatus 100 further includes two light-reflecting modules 6 that substitute for the lighting modules 3′ of the first preferred embodiment.

The light-reflecting modules 6 are mounted respectively to the lateral sides 12′ of the frame 1 for reflecting the light generated by the lighting module 3. In this embodiment, the light-reflecting modules 6 have the same mechanical structure as that of the lighting modules 3′. That is, each light-reflecting module 6 has a main body 60, and a plurality of engaging blocks 61 that extend from the main body 60 and engage respectively the engaging holes 121 in a corresponding lateral side 12′ of the frame 1 and that serve as a third connecting unit connected to the first connecting unit of the corresponding lateral side 12′ of the frame 1, and a plurality of positioning grooves 612 formed respectively in the engaging blocks 61 and serving as a second positioning unit engaging the first positioning unit of the corresponding lateral side 12′ of the frame 1. Each engaging block 31 of each light-reflecting module 6 is formed with a connecting hole 611 engaging threadly a corresponding screw fastener 5.

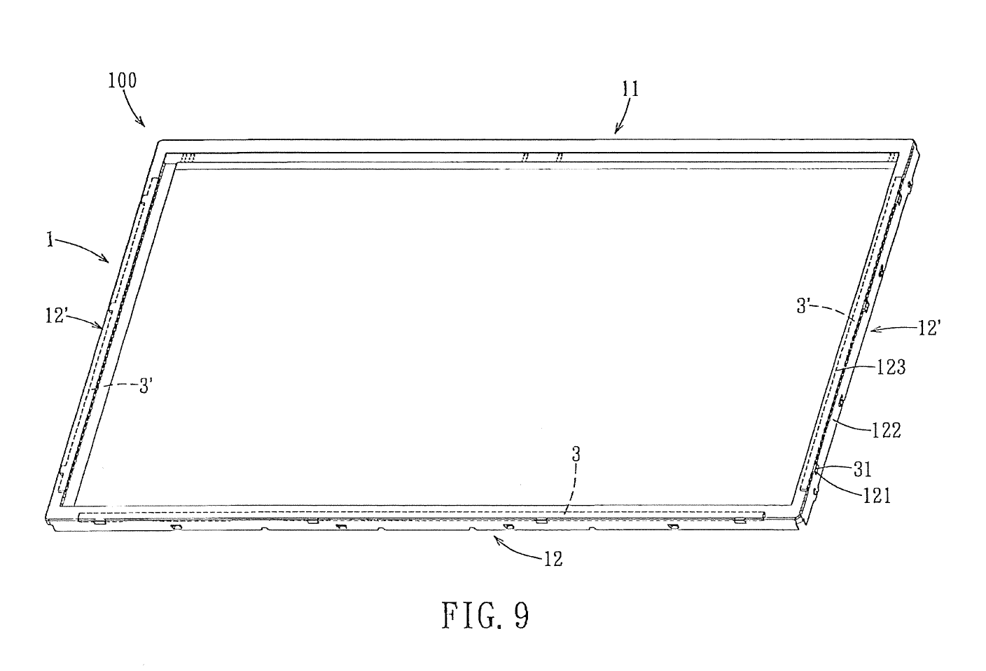

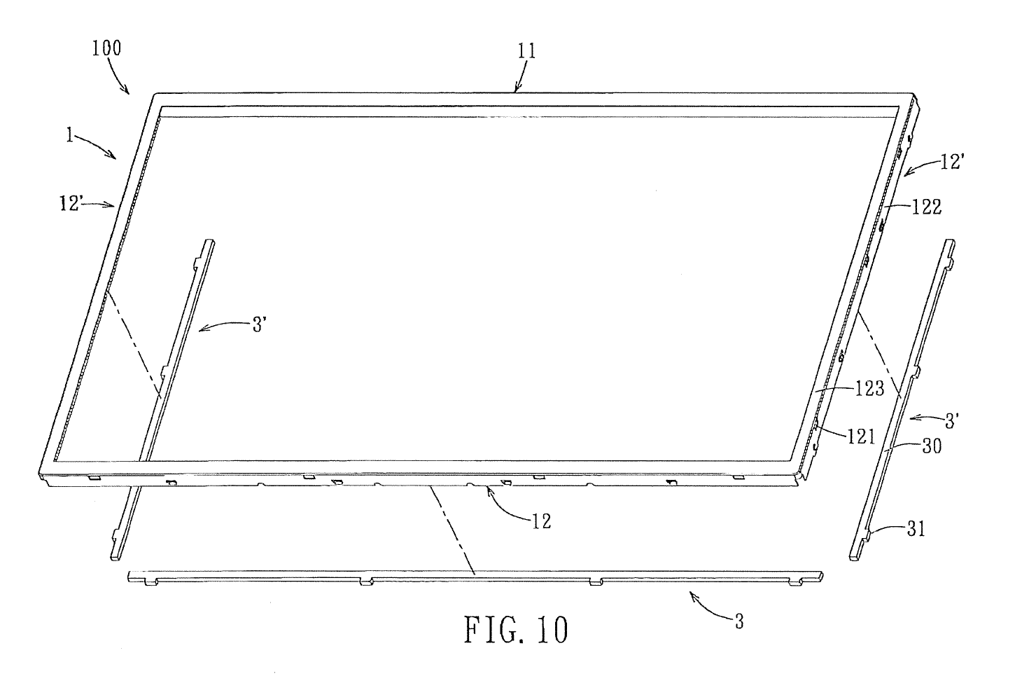

FIGS. 9 and 10 illustrate the third preferred embodiment of an optical touch apparatus 100 according to this invention, which is a modification of the first preferred embodiment. In this embodiment, the first positioning unit of each of the front and lateral sides 12, 12′ is omitted. The second positioning unit of each of the lighting modules 3, 3′ is omitted. The engaging blocks 31 of each of the lighting modules 3, 3′ extends into and engage the engaging holes 121 in the side plate 122 of a corresponding one of the front and lateral sides 12, 12′ of the frame 1, respectively.

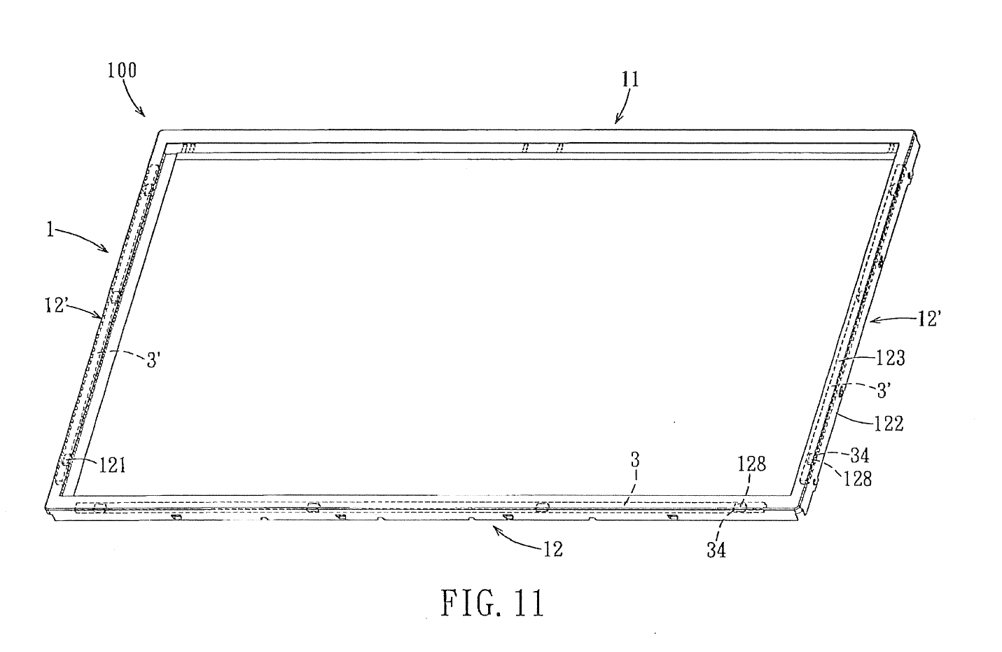

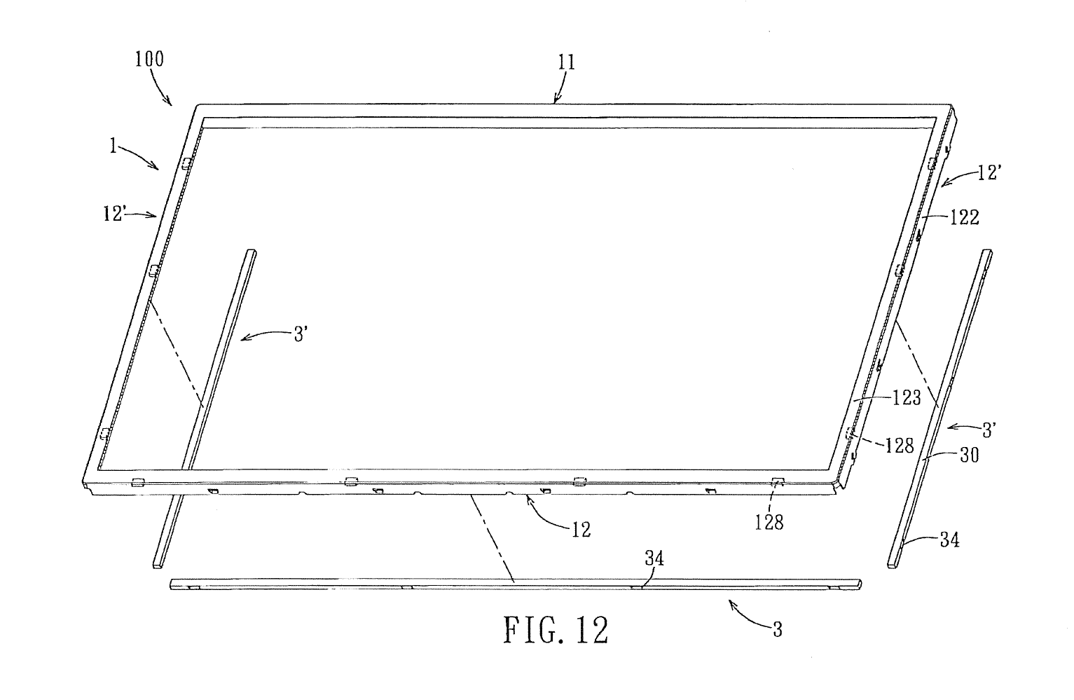

FIGS. 11 and 12 illustrate the fourth preferred embodiment of an optical touch apparatus 100 according to this invention, which is a modification of the third preferred embodiment. In this embodiment, the main body 30 of each of the lighting modules 3, 3′ is formed with a plurality of engaging holes 34 that serve as the second connecting unit. Each of the front and lateral sides 12, 12′ has a plurality of engaging blocks 128 extending inward from the side plate 122 and serving as the first connecting unit. The engaging blocks 128 of each of the front and lateral sides 12, 12′ extend into and engage the engaging holes 34 in the main body 30 of a corresponding one of the lighting modules 3, 3′, respectively.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An optical touch apparatus comprising:
a frame having a first side and two corners, said first side of said frame having a first connecting unit;
a lighting module for generating light, said lighting module having a second connecting unit connected to said first connecting unit of said first side of said frame such that said lighting module is mounted to said first side of said frame; and
two optical sensors mounted on said frame and disposed respectively at said corners of said frame, each of said optical sensors sensing the light generated by said lighting module.

2. The optical touch apparatus as claimed in claim 1, wherein:
said lighting module is formed with at least one engaging hole serving as said second connecting unit; and
said first side of said frame has at least one inward extending engaging block extending into and engaging said engaging hole in said lighting module, said engaging block serving as said first connecting unit.

3. The optical touch apparatus as claimed in claim 1, wherein:
said first side of said frame is formed with at least one engaging hole serving as said first connecting unit; and
said lighting module has at least one engaging block extending into and engaging said engaging hole in said first side of said frame, said engaging block serving as said second connecting unit.

4. The optical touch apparatus as claimed in claim 3, wherein said first side of said frame has a side plate, a stop plate extending inward from a top side of said side plate, said engaging block extending inward from said side plate.

5. The optical touch apparatus as claimed in claim 3, wherein said first side of said frame has a side plate formed with said engaging hole, a stop plate extending inward from a top side of said side plate, and a clipping tab extending inward from said side plate such that said engaging block of said lighting module is clamped between said stop plate and said clipping tab.

6. The optical touch apparatus as claimed in claim 5, wherein:
said stop plate of said first side of said frame is formed with at least one through hole; and
said engaging block of said lighting module formed with at least one connecting hole corresponding to said through hole in said top plate of said first side of said frame;
said optical touch apparatus further comprising at least one screw fastener extending through said through hole in said stop plate of said first side of said frame and secured in said connecting hole in said engaging block of said lighting module.

7. The optical touch apparatus as claimed in claim 6, wherein said first side of said frame further has a first positioning unit, and said lighting module further has a second positioning unit engaging said first positioning unit.

8. The optical touch apparatus as claimed in claim 7, wherein:
said stop plate of said first side of said frame is formed with at least one positioning hole serving as said first positioning unit; and
said lighting module has at least one positioning protrusion extending into and engaging said positioning hole in said top plate of said first side of said frame, said positioning protrusion serving as said second positioning unit.

9. The optical touch apparatus as claimed in claim 7, wherein:
said top plate of said first side of said frame has at least one positioning protrusion extending toward said lighting module and serving as said first positioning unit; and
said lighting module is formed with at least one positioning groove engaging said positioning protrusion of said top plate of said first side of said frame, said positioning groove serving as said second positioning unit.

10. The optical touch apparatus as claimed in claim 9, wherein:
said through hole in said stop plate of said first side of said frame extends through said positioning protrusion; and
said engaging block of said lighting module is formed with said positioning groove that is defined by an inner surrounding wall and a groove-bottom wall, said groove-bottom wall being formed with said connecting hole.

11. The optical touch apparatus as claimed in claim 1, wherein said frame further has a second side that has a first connecting unit;
said optical touch apparatus further comprising a light-reflecting module for reflecting the light generated by said lighting module, said light-reflecting module having a third connecting unit connected to said first connecting unit of said second side of said frame such that said light-reflecting module is mounted to said second side of said frame.

12. The optical touch apparatus as claimed in claim 11, wherein:
said light-reflecting module is formed with at least one engaging hole that serves as said third connecting unit; and
said second side of said frame has at least one inward extending engaging block extending into and engaging said engaging hole in said light-reflecting module, said engaging block of said second side of said frame that serves as said first connecting unit of said second side of said frame.

13. The optical touch apparatus as claimed in claim 11, wherein:
said second side of said frame is formed with at least one engaging hole that serves as said first connecting unit thereof; and
said light-reflecting module has at least one engaging block extending into and engaging said engaging hole in said second side of said frame, said engaging block serving as said third connecting unit.

14. The optical touch apparatus as claimed in claim 13, wherein said second side of said frame has a side plate, a stop plate extending inward from a top side of said side plate, said engaging block extending inward from said side plate.

15. The optical touch apparatus as claimed in claim 13, wherein said second side of said frame has a side plate formed with said engaging hole, a stop plate extending inward from a top side of said side plate, and a clipping tab extending inward from said side plate such that said engaging block of said light-reflecting module is clamped between said stop plate and said clipping tab.

16. The optical touch apparatus as claimed in claim 15, wherein:
said stop plate of said second side of said frame is formed with at least one through hole; and
said engaging block of said light-reflecting module formed with at least one connecting hole corresponding to said through hole in said top plate of said second side of said frame;
said optical touch apparatus further comprising at least one screw fastener extending through said through hole in said stop plate of said second side of said frame and secured in said connecting hole in said engaging block of said light-reflecting module.

17. The optical touch apparatus as claimed in claim 16, wherein said second side of said frame further has a first positioning unit, and said light-reflecting module further has a second positioning unit engaging said first positioning unit.

18. The optical touch apparatus as claimed in claim 17, wherein:
said stop plate of said second side of said frame is formed with at least one positioning hole serving as said first positioning unit; and
said light-reflecting module has at least one positioning protrusion extending into and engaging said positioning hole in said top plate of said second side of said frame, said positioning protrusion serving as said second positioning unit.

19. The optical touch apparatus as claimed in claim 17, wherein:
said top plate of said second side of said frame has at least one positioning protrusion extending toward said light-reflecting module and serving as said first positioning unit; and
said light-reflecting module is formed with at least one positioning groove engaging said positioning protrusion of said top plate of said second side of said frame, said positioning groove serving as said second positioning unit.

20. The optical touch apparatus as claimed in claim 19, wherein:
said through hole in said stop plate of said second side of said frame extends through said positioning protrusion; and
said engaging block of said light-reflecting module is formed with said positioning groove that is defined by an inner surrounding wall and a groove-bottom wall, said groove-bottom wall being formed with said connecting hole.

21. The optical touch apparatus as claimed in claim 1, further comprising:
a panel module mounted in said frame and including a circuit board;
a first electric wire interconnecting electrically said lighting module and said circuit board; and
two second electric wires each interconnecting electrically a corresponding one of said optical sensors and said circuit board.

22. The optical touch apparatus as claimed in claim 1, further comprising at least one additional optical sensor mounted on said frame and disposed between said optical sensors.
